(19) United States
(12) Patent Application Publication
(10) Pub. No.: US 2011/0107155 A1
(43) Pub. Date: May 5, 2011

(54) NETWORK FAULT DETECTION APPARATUS AND METHOD

(76) Inventors: Shunsuke Hirose, Tokyo (JP); Kenji Yamanishi, Tokyo (JP)

(21) Appl. No.: 12/812,471

(22) PCT Filed: Jan. 13, 2009
(86) PCT No.: PCT/JP2009/050318

§ 371 Date: Dec. 2, 2010

(30) Foreign Application Priority Data
Jan. 15, 2008 (JP) 2008-005603

(51) Int. Cl. G06F 11/30; G06F 15/18; G06F 17/10

(52) U.S. Cl. 714/48; 714/E11.179

(57) ABSTRACT

A network fault detection apparatus includes: data distribution learning units (2, 3, 4, and 5) that take, as input, data in which the state of the network is expressed by matrix variables of a hierarchical structure and that learn the state of the network as the probability distribution of the matrix variables, and fault detection units (6 and 7) that, based on the result of learning by the data distribution learning unit, detect, as a network fault, a state in which the probability distribution transitions from a distribution that indicates the normal state of the network to a distribution that indicates another state.

### TECHNICAL FIELD

The present invention relates to a technique of detecting faults of a network.

### BACKGROUND ART

Points that should be considered in detecting faults of a network include the following properties of a network.

The first property is the existence of interaction for each vertex on a network. It is necessary to consider the state of the network or the manner in which the network behaves under the influence of this interaction, i.e., the overall structure (graph structure) of the network. The overall structure here referred to is, for example, a structure that indicates, for example, that every vertex is working uniformly or that there are a small number of important vertices that are being operated predominately.

Due to the existence of this first property, the detection of a network fault is problematic when merely examining individual elements. For example, although an increase in the amount of traffic of a particular portion of a network cannot be considered a network fault, a simultaneous increase in the amount of traffic of other parts can be called a network fault. Considering the overall structure of a network enables detection of a network fault in which, for example, although the network was in a normal state and the amount of traffic was uniform, the amount of traffic becomes over-concentrated in one area due to general infection by a virus and the start of a virus attack upon the server.

The second property is that the amount of traffic in a network changes with time, and further, that the network structure, whereby one vertex is connected to another vertex, also changes with time. Due to this second property, the detection of a network fault requires learning what the normal state of the network is. For example, the circumstances under which the amount of traffic is extremely heavy, during a late nighttime slot, but under which the amount of traffic is a normal, during a daytime slot, correspond to the second property.

One example of a network fault detection method that takes the above properties into consideration is the method disclosed in document of JP-A-2005-216066 (hereinbelow referred to as Patent Document 1). In the method disclosed in Patent Document 1, the normal state of a vector is learned by taking as input the maximum eigenvector of a matrix that has as a component a characteristic amount of a network, and a large variation from the normal vector is detected as an abnormality.

The characteristic structure of a network is described in the following Non-Patent Documents 1 to 3.
1. A. L. Barabasi, and R. Albert, ‘Emergence of Scaling in Random Networks,’ Science Vol. 286, pp. 509-512 (1999).
2. C. /Song, S. Havlin, and H. Makse, ‘Self-similarity of complex networks,’ Nature Vol. 433, pp. 392-395 (2005).
3. Jure Leskovec and Christos Faloutsos, ‘Scalable Modeling of Real Graphs using Kronecker Multiplication,’ ICML 2007

Non-Patent Document 1 shows that; regarding the structure of networks, most actual networks have a scale-free property. Here, “scale-free property” refers to the property whereby, while most of the vertices of a network have a few links, a few vertices have a vast number of links. If a Web page is offered as an example, a popular page is referred to from an enormous number of pages whereas the other overwhelming majority of pages have only a small number of reference sources. This property is referred to as a scale-free property.

Non-Patent Document 2 reports that networks having a scale-free property have self-similarity property. The self-similarity property is the property whereby the analogous reduction of an entirety produces a shape identical to the original. More specifically, self-similarity is the property by which the same form is seen whether a structure is viewed indistinctly from a distance or viewed clearly from close up.

As one method of using a matrix to represent a network that has a scale-free property, Non-Patent Document 3 describes a method of expressing a matrix as the direct product of the matrix. The direct product of n×m matrix U and p×q matrix V is defined by the following pn×qm matrix:

$$U ⊗ V = ( \begin{matrix}{U}_{11} V & {U}_{12} V & … & {U}_{1 m} V \\ {U}_{21} V & {U}_{22} V & … & {U}_{2 m} V \\ ⋮ & ⋮ & & ⋮ \\ {U}_{n 1} V & {U}_{n 2} V & … & {U}_{nm} V\end{matrix} ) \qquad [ Equation 1 ]$$

Although not a technique relating to the structure of a network, a technique is described in JP-A-2005-141601 (hereinbelow referred to as “Patent Document 2”) for selecting an optimum structure when there is a plurality of structures. According to this technique, structures that minimize an information criterion are successively selected as the optimum structure from among structures that have been prepared in advance, and these structures therefore correspond to the change over time of a structure.

### DISCLOSURE OF THE INVENTION

In the traffic on a network, a hierarchical structure sometimes appears in various locations in which there are hubs that perform important work in a particular area, and when viewed over a wider area, there are, in turn, hubs that consolidate these hubs. In a network having this type of hierarchical structure, the occurrence of an abnormality such as the occurrence of a worm may result in the entire network exhibiting the same type of traffic or only a portion of the entire network exhibiting peculiar behavior. In order to detect this type of abnormality, the hierarchical structure of the network must be considered.

In the method described in Patent Document 1, the conversion of input to an eigenvector prevents information regarding the structure of the network from being contained in the output. As a result, it is impossible to know what type of change occurred (how the overall structure changed) to cause the determination that a network is abnormal.

Non-Patent Documents 1 and 2 disclose the existence of scale-free structures or self-similar structures as characteristic structures of actual networks. However, Non-Patent Documents 1 and 2 make no disclosure regarding methods of detecting changes of hierarchical structures that are self-similar or scale-free.

Patent Document 2 describes a method of fault detection that detects changes in the structure of the probability distribution of input data. However, the method described in Patent Document 2 is a method in which structures that can serve as candidates are all prepared and the optimum structure is then selected from among these structures. Patent Document 2 makes absolutely no disclosure regarding technical concepts relating to network fault detection that takes hierarchical structure into consideration.

It is an object of the present invention to provide a network fault detection apparatus and method that can take into consideration the overall structure of a network to detect faults and thus solve the above-described problems.

The network fault detection apparatus of the present invention for achieving the above-described object includes: a data distribution learning unit that: takes as input data that represent the state of a network by matrix variables of a hierarchical structure and that learns the state of the network as the probability distribution of the matrix variables; and a fault detection unit that, based on the result of learning by the data distribution learning unit, detects, as a fault of the network, a state in which the probability distribution transitions from a distribution that indicates the normal state of the network to a distribution that indicates another state.

In addition, the network fault detection method of the present invention is carried out in a computer system that takes as input data in which the state of a network is represented by matrix variables of a hierarchical structure, the method including steps in which a data distribution learning unit, based on the data that are received as input, learns the state of the network as a probability distribution of matrix variables, and a fault detection unit, based on the results of learning by the data distribution learning unit, detects, as a fault of the network, a state in which the probability distribution transitions from a distribution that indicates the normal state of the network to a distribution that indicates another state.

### BRIEF DESCRIPTION OF THE DRAWINGS

FIG. 1 is a block diagram showing the configuration of a network fault detection apparatus that is an exemplary embodiment of the present invention; and

FIG. 2 is a flow chart for explaining the fault detection process carried out in the network fault detection apparatus shown in FIG. 1.

### EXPLANATION OF REFERENCE NUMBERS

1 data input apparatus
2 structure candidate enumeration means
3 model generation means
4 distribution learning means
5 model selection means
6 fault score calculation means
7 structural change detection means
8 output apparatus

### BEST MODE FOR CARRYING OUT THE INVENTION

An exemplary embodiment in the present invention is described hereinbelow with reference to the accompanying drawings.

An exemplary embodiment of the present invention is next described with reference to the accompanying drawings.

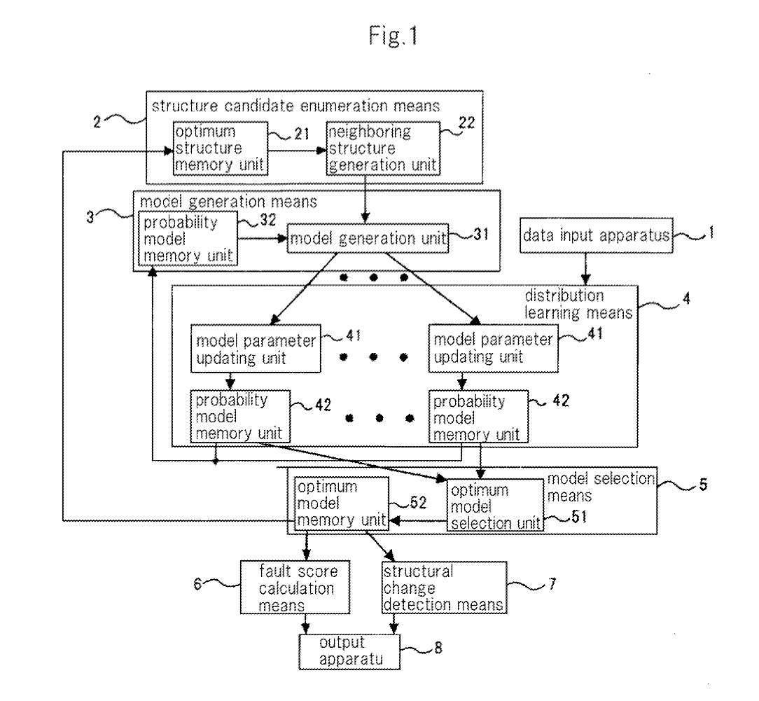

FIG. 1 is a block diagram showing the configuration of the network fault detection apparatus that is an exemplary embodiment of the present invention. Referring to FIG. 1, the network fault detection apparatus includes: data input apparatus 1, structure candidate enumeration means 2, model generation means 3, distribution learning means 4, model selection means 5, fault score calculation means 6, structural change detection means 7, and output apparatus 8.

Data input apparatus 1 is a component for providing as input data that represent the state of a network by parameters of a hierarchical structure, and more specifically, tensor data including characteristic amounts of the network as components. The input data are successively applied as input together with time, or are given information relating to the time at which the data were generated. In this case, the characteristic amounts of a network are, for example, the amount of traffic (or a function of the amount of traffic) between nodes, or an amount that represents the presence or absence of a connection between nodes by binary information 0 or 1. The input data may be a typical ranked tensor type or a matrix type.

Matrix data represent data including two degrees of freedom (i and j) that designate data, such as D(i, j). For example, in the case of data D(i, j) that express links between Web pages, D(i, j) expresses the presence or absence of links between the pages, i and j each expressing one Web page. When a link is formed from page i to page j, D(i, j)=1. When a link is not formed from page i to page j, D(i, j)=0.

Tensor data are data including two or more degrees of freedom that designate data, such as E(i, j, k) or F(i, j, k, l). A case including three degrees of freedom such as E(i, j, k) is referred to as a third-order tensor. A case including four degrees of freedom such as F(i, j, k, l) is referred to as a fourth-order tensor. The matrix type can be called a second-order tensor.

For example, in data E(i, j, k) that records the type and volume of communication of a network, i and j each represent one server, and k represents the type (ftp, smtp, ssh . . . ) of communication. E(i, j, k) represents the amount of communication on the network. This amount of communication indicates the amount for communication of type k in communication from server i to server j.

The operation of each part of the network fault detection apparatus of the present exemplary embodiment is described below taking as an example input data of the matrix type.

Structure candidate enumeration means 2 enumerates neighboring structures of a hierarchical structure that is selected as the optimum structure at the current time. However, when it is not necessary to economize the amount of calculation, structure candidate enumeration means 2 may enumerate all possible structures.

The principal parts of structure candidate enumeration means 2 are made up by optimum structure memory unit 21 and neighboring structure generation unit 22. Optimum structure memory unit 21 stores information of the hierarchical structure that is selected as the optimum structure at the current time. Neighboring structure generation unit 22 enumerates neighboring structures of the optimum structure based on the optimum structure that is stored in optimum structure memory unit 21 and supplies this information to model generation means 3.

When an optimum structure has not been decided, i.e., when data are first received as input, neighboring structure generation unit 22 selects one structure at random from among possible structures and takes this as the optimum structure. In this case, a hierarchical structure is a typical graph-type hierarchical structure and includes, for example, tree structures, self-similar structures, and scale-free structures.

A structure is, for example, a direct-product structure of a matrix. The direct-product structure of a matrix is typically expressed by:

Σ=σ1×σ2×σ3 . . . ×σd [Equation 2]

and each element (σ) corresponds to a hierarchical structure. The possible structures are hierarchical structures that can be created by dividing this Σ. Possible hierarchical structures are determined by the number of a that are multiplied to express Σ and the number of dimensions of each σ. For example, in the case of a structure expressed by:

Σ=σ1×σ2(σ1=2 dimensions, σ2=15 dimensions) [Equation 3]

Σ is 30 dimensions (corresponding to the dimensions of the input data). If the dimensions of the input data are known, the possible structures can be enumerated. When the network fault detection apparatus is activated, information relating to the dimensions of the input data is supplied from data input apparatus 1 to neighboring structure generation unit 22.

The following explanation takes as an example a case in which input data (the characteristic amount of the network) from data input apparatus 1 has a direct-product structure.

When the input data are assumed to be T, the fact that T has a direct-product structure indicates that T is expressed by the direct product of two or more matrices or two or more typical tensors of a typical order, as in the following equation:

T=U [symbol] V [Equation 4]

According to this equation, T has a hierarchical structure whereby input data T are expressed by the product of a value of a hierarchy U and a value of hierarchy V. As described in Non-Patent Document 3, a direct-product structure corresponds to a scale-free structure and is one structure of an actual network.

A method of enumerating neighboring structures is next described.

In the case of a direct-product structure in which parameter matrix MK of the K^{th} model is expressed by:

Mₖ=μₖ₁ [symbol] . . . [symbol] μ_{kd}_{ₖ} [Equation 5]

the hierarchical structure is expressed by (dk), which indicates the number of matrices that produce the direct product by which the hierarchical structure is written, and by each dimension of matrices μl-μdk of each hierarchy. A structure can be expressed by:

(s₁, s₂, s₃, . . . , s_{dk}) [Equation 6]

in which the dimensions of the matrices of each hierarchy are arranged.

The neighboring structures of the optimum structure are structures that resemble the optimum hierarchical structure. When a direct-product structure is considered, structures including a direct-product structure that resemble the optimum structure are assumed to be neighboring structures. For example, when the optimum structure is expressed as (s_{—}1, s_{—}2, . . . , s_d), the neighboring structures are structures such as:

(1) Structures in which the dimensions of two adjacent hierarchies are exchanged:

(s₂, s₁, s₃, . . . , s_{d}) [Equation 7]

(2) Structures in which two adjacent hierarchies are consolidated as one:

(s₂, s₃, . . . , s_{d}) [Equation 8]

(3) Structures in which one hierarchy is divided into two:

(s₁, s′₂, s″₂, s₃, . . . , s_{d}) [Equation 9]

Model generation means 3 generates a plurality of models of the probability distribution of the input data. Input data are expressed as “X.”. The probability distribution of matrix variables including matrix-type parameters that have a direct-product structure is used as a model of the distribution of data. For example, the normal distribution of matrix variables can be used as the distribution.

$$p ( X \vert Σ , Ψ , M ) = \frac{1}{{( 2 π )}^{\frac{{n}^{2}}{2}} {( det Σ )}^{\frac{n}{2}} {( det Ψ )}^{\frac{n}{2}}} exp [ - \frac{1}{2} tr [ {\sum }^{- 1} ( X - M ) {{Ψ}^{- 1} ( X - M )}^{†} ] ] \qquad [ Equation 10 ]$$

A model of the distribution of data may be the probability distribution of matrix variables including matrix-type parameters that have a hierarchical structure. In this case, the data distribution model is assumed to be the normal distribution of matrix variables for which the parameter matrix has a direct-product structure.

Of the plurality of generated models, the k^{th} model is given by:

pₖ(X|Σₖ, Ψₖ, Mₖ) [Equation 11]

Direct-product structures that correspond to structures that have been enumerated in structure candidate enumeration means 2 are given to the parameters of each model. The depth of the hierarchy of the k^{th} model is assumed to be dk. This depth dk indicates the number of direct products by which parameters are expressed.

Σₖ=σₖ₁ [symbol] . . . [symbol] σ_{kd}_{ₖ}

Mₖ=μₖ₁ [symbol] . . . [symbol] μ_{kd}_{ₖ}

Ψₖ=ψₖ₁ [symbol] . . . [symbol] ψ_{kd}_{ₖ} [Equation 12]

Model generation means 3 is composed of model generation unit 31 and probability model memory unit 32. Distribution learning means 4 is composed of a plurality of model parameter updating unit 41 and a plurality of probability model memory units 42.

Model generation unit 31 acquires information of the parameters and structure of the model of the preceding step from probability model memory unit 32, accepts information of the structure of a newly generated model from neighboring structure generation unit 22, and supplies information of the parameters and structure of a plurality of models to each model parameter updating unit 41.

When the structure obtained from neighboring structure generation unit 22 is contained among the plurality of models at the time of the preceding step that were sent from probability model memory unit 32, the parameters of the time of the preceding step are carried over without alteration. When the structure obtained from neighboring structure generation unit 22 is not contained among the plurality of models at the time of the preceding step, i.e., in the case of a model that corresponds to a structure newly generated in structure candidate enumeration means 2 according to a change of the optimum structure, the parameters are determined to approach the parameters of a model that corresponds to the optimum structure. For example, when the parameter of the optimum model is σ and the parameter of a model that corresponds to a newly generated structure is in the form σ′1×σ′2, σ′1 and σ′2 are found that minimize the Frobenius norm:

∥σ−σ′₁ [symbol] σ′₂∥_{F} [Equation 13]

and these are taken as the values of the parameters of the new model.

Model learning means 4 updates the parameters of the plurality of models prepared in model generation means 3. Model parameter updating unit 41 accepts information of the models at the time of the preceding step from model generation unit 31, accepts input data from input apparatus 1, and updates the parameters of the models. One method of calculating parameters at time t is a method in which the input data at time j are taken as Xj and parameters are determined such that the log likelihood given by the following equation is maximized:

$$- {\sum }_{j = 0}^{t} log p ( {X}_{j} \vert {\sum }_{k} , {Ψ}_{k} , {M}_{k} ) \qquad [ Equation 14 ]$$

Alternatively, parameters may be determined such that the log likelihood within time width L given by the following equation is maximized:

$${\sum }_{J = t - L + 1}^{t} log p ( {X}_{j} \vert {\sum }_{k} , {Ψ}_{k} , {M}_{k} ) \qquad [ Equation 15 ]$$

Alternatively, parameters may be determined such that the following log likelihood, in which past weighting is reduced, is maximized. Here, 0<r<1. This method of determining parameters is typically referred to as a “discounting learning method.”

$${\sum }_{j = 0}^{t} {r ( 1 - r )}^{t - j} log p ( {X}_{j} \vert {\sum }_{k} , {Ψ}_{k} , {M}_{k} ) \qquad [ Equation 16 ]$$

A method of determining parameters such as in the examples above is referred to as a learning method.

The information of the updated parameters and structures is stored in probability model memory unit 42. The information stored in probability model memory unit 42 is sent to probability model memory unit 32 each time information is updated.

Model selection means 5 calculates an information criterion for each model that has been learned in model learning means 4 and selects the model in which this value is a minimum as the optimum model. Model selection means 5 is composed of optimum model selection unit 51 and optimum model memory unit 52. Optimum model selection unit 51 selects one optimum model from the information of a plurality of models supplied from each of probability model memory units 42. The method of selecting an optimum model is described below.

The parameters of the k^{th} model at time j are integrated and expressed as:

θₖ^{(j)} [Equation 17]

and the direct-product structure of the k^{th} model at time j is expressed as:

$${s}_{k}^{( j )} = ( {( {s}_{k}^{( j )} )}_{1} , {( {s}_{k}^{( j )} )}_{2} , … , {( {s}_{k}^{( j )} )}_{{d}_{k}^{( j )}} ) \qquad [ Equation 18 ]$$

The optimum model at time j is expressed as:

kⱼ* [Equation 19]

The following case is taken up as an example of a method of using an information criterion to select an optimum model.

When a discounting learning method is used as the learning method, a method can be used in which the following quantity known as the predictive probability complexity (Universal coding, information, prediction, and estimation, IEEE Transactions on Information Theory, 30, pp. 629-636, 1984) is used as the information criterion for model selection, and model k that minimizes this value is selected as the optimum model.

$${\sum }_{j = 0}^{t - 1} - log p ( {X}_{j} \vert {θ}_{k}^{( j - 1 )} ) \qquad [ Equation 20 ]$$

When seeking transitions of models of a particular range in a batch without depending on a learning method, a method can be used to determine the series of optimum models:

(k₁*, k₂*, . . . , kₜ*) [Equation 24]

that minimizes the following batch dynamic model selection criterion (refer to Patent Document 2):

$$- {\sum }_{j = 1}^{t} log p ( {X}_{j} \vert {θ}_{{k}_{j}}^{( j - 1 )} ) - {\sum }_{j = 1}^{t} log p ( {k}_{j} \vert {k}^{j - 1} ) \qquad [ Equation 23 ]$$

that is expressed using the series of models up to time j−1:

k^{j-1}=(k₀, k₁, . . . , kⱼ₋₁) [Equation 21]

and the transition probability of models:

p(kⱼ|k^{j-1}) [Equation 22]

When a learning method other than the discounting type is used or when a reduction of the amount of computation is desired, a method can be used of calculating the value of a function that takes as arguments the number of parameters, the number of data items, and the likelihood of data within a particular time width W, and then of selecting as the optimum model the model that minimizes this value.

An information criterion such as MDL, AIC, and RIC can be used as the function that takes as arguments the number of parameters, the number of data items, and the likelihood of data. For example, when MDL is used as the information criterion, the model that minimizes the following quantity may be selected as the optimum model.

$$- {\sum }_{j = t - W + 1}^{t} log p ( {X}_{j} \vert {θ}_{k}^{( t )} ) + \frac{1}{2} {\sum }_{t = 1}^{{d}_{k}} {( {( {s}_{k} )}_{t} )}^{2} log W \qquad [ Equation 25 ]$$

Fault score calculation means 6 uses the optimum model that was selected in model selection means 5 to calculate a score of the degree of abnormality of data. The fault score is a quantity that expresses the extent to which input data differ from normal data; the greater values thereof correspond to abnormal data that normally do not occur. Investigating points at which the fault score suddenly increases enables the detection of sporadic faults.

As an example, the following quantity can be used as a fault score.

−log p(Xₜ|θₖ_{ⱼ}*^{(t)}) [Equation 26]

When the input is, for example, the amount of communication between nodes of a network, a high fault score corresponds to a case in which a network is placed in a state that differs from the normal state such as a case in which the amount of simultaneous communication increases at two sites at which the simultaneous communication amount is normally not great, or a case in which the overall amount of communication becomes greater than the normal amount of communication. Accordingly, in this example, monitoring the fault score enables detection of an abnormality of the state of communication on the network. The calculated fault score is sent to output apparatus 8.

When a threshold value for scores can be set in advance, information of whether the score exceeds this value or not (abnormal or not) should be sent to output apparatus 8.

Structural change detection means 7 detects changes of the hierarchical structure that is behind the data. When a change occurs in the hierarchical structure held by parameters of an optimum model wherein the hierarchical structure is:

$${s}_{{k}_{t}^{*}}^{( t )} = ( {( {s}_{{k}_{t}^{*}}^{( t )} )}_{1} , {( {s}_{{k}_{t}^{*}}^{( t )} )}_{2} , … , {( {s}_{{k}_{t}^{*}}^{( t )} )}_{{d}_{{k}_{t}^{*}}^{( t )}} ) \qquad [ Equation 27 ]$$

this change is detected as a change of the hierarchical structure. Changes can also be detected as a change of the structure when the structure within one hierarchy changes even though the hierarchical structure itself does not change. As a method of detecting such a structural change within any of the hierarchies, a method can be used of calculating the amount of change from the preceding time of the parameter matrix of each hierarchy and then detecting abrupt changes of this amount.

The following quantities can be used as the amount of change from the preceding time of a parameter matrix.

d(μₖ_{ₜ₋₁}*ᵢ,μₖ_{ₜ}*ᵢ)=tr[82 ₖ_{ₜ₋₁}*ᵢ,μₖ_{ₜ}*ᵢ)²] [Equation 28]

For example, in a network including similar structures in which there are hubs that perform important work in a particular area, and further, when viewed over a wider area, there are hubs in which these hubs are consolidated, when the input is the amount of communication on the network, the occurrence of a change of structure corresponds to a general abnormality of communication that is not temporary in which the same type of traffic occurs over the entire network or in which strange behavior occurs in only one portion of the network due to the occurrence of an abnormality such as the occurrence of a worm. In this example, an abnormality of the entire communication structure that is not temporary can therefore be detected by monitoring changes of the structure.

The detection or nondetection of the above-described two changes is sent to output apparatus 8.

Information such as information relating to the optimum structure may further be sent to output apparatus 8.

Output apparatus 8 accepts the results obtained by fault score calculation means 6 and structural change detection means 7 and supplies or displays these results.

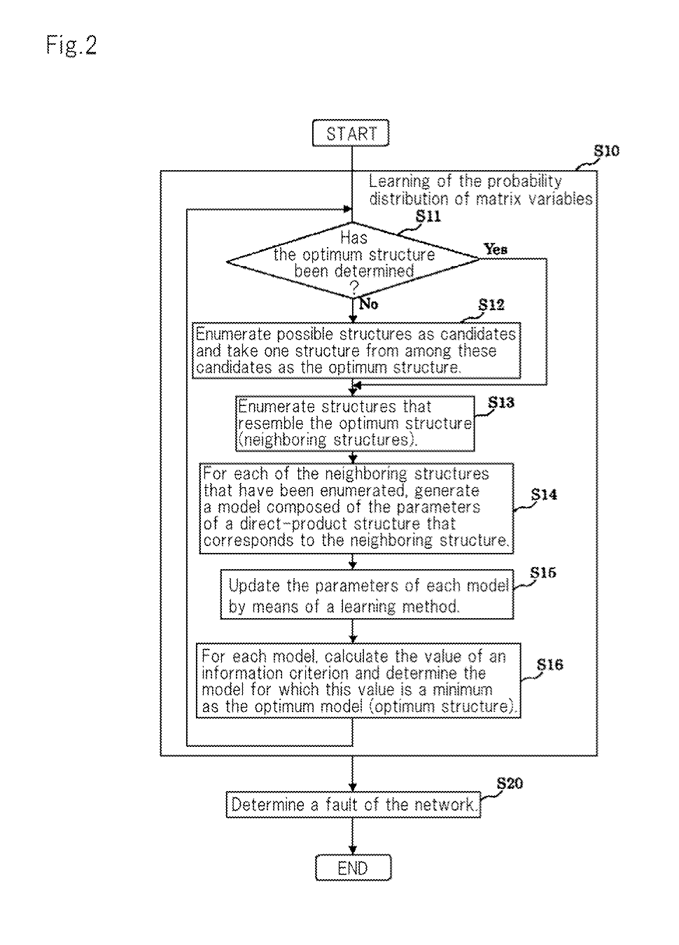

FIG. 2 is a flow chart for explaining the fault detection process carried out in the network fault detection apparatus shown in FIG. 1.

Referring to FIG. 2, the fault detection process includes: Step S10 of taking, as input, data in which the state of the network is expressed by matrix variables of a hierarchical structure and learning the distribution of the input data as the probability distribution of the matrix variables; and Step S20 of determining an abnormality of the network when the probability distribution transitions from the normal state to another state.

In the process of Step S10, neighboring structure generation unit 22 checks whether information of an optimum structure is stored in optimum structure memory unit 21 (Step S11). If information of an optimum structure is not stored in optimum structure memory unit 21 (the state immediately following activation), neighboring structure generation unit 22, based on information relating to the dimensions of input data that have been supplied from input apparatus 1 in advance, enumerates possible structures as candidates and uses a structure selected at random from these candidates as the optimum structure (Step S12).

After Step S12, or when information of optimum structures is stored in optimum structure memory unit 21, neighboring structure generation unit 22 enumerates structures (neighboring structures) that resemble the optimum structure. Model generation unit 31 next generates a model composed of parameters of a direct-product structure that corresponds to a neighboring structure for each of the neighboring structures that have been enumerated by neighboring structure generation unit 22 (Step S14). As the parameters of models that are to be generated in this generation of models, model generation unit 31 refers to parameters in the optimum structure and to parameters of models that have been saved in probability model memory unit 32. Each model that is generated in model generation unit 31 is supplied to a respective model parameter updating unit 41.

Each of model parameter updating units 41 next updates the parameters of the models supplied from model generation unit 31 by a learning method (Step S15). Each model for which parameters have been updated in each of model parameter updating units 41 is stored in a corresponding probability model memory unit 42. Information of models for which parameters have been updated and that have been stored in probability model memory units 42 is supplied to probability model memory unit of model generation means 3.

Optimum model selection unit 51 next calculates the value of the information criterion for models that are stored in each of probability model memory units 42 and takes as the optimum model the model for which this value is a minimum (Step S16). The optimum model is stored in optimum model memory unit 52. The information of the optimum model that is stored in optimum model memory unit 52 is supplied to optimum structure memory unit 21 of structure candidate enumeration means 2.

Steps S11-S16 described above are executed repeatedly each time data are supplied from data input apparatus 1.

In Step S20, the distribution (probability distribution of matrix variables) of the optimum models obtained in Step S16 in the process of repeating Steps S11-S16 is monitored, and when this distribution transitions to another state from the normal state, a fault of the network is determined. This process of determining faults includes a first fault determination process based on the calculation result by fault score calculation means 6 and a second fault determination process based on the detection result realized by structural change detection means 7. Either the first of the second fault determination process may be carried out in Step S20.

The network fault detection apparatus described hereinabove is one example of the present invention, and its configuration and operation can be modified as appropriate within a range that does not depart from the spirit of the invention. For example, in the configuration shown in FIG. 1, a configuration is also possible which has either fault score calculation means 6 or structural change detection means 7.

In addition, the network fault detection apparatus can be constructed by means of a computer system that operates according to a program. The principal parts of the computer system are made up from: a memory apparatus that stores a program and data, an input apparatus such as a keyboard or a mouse, a display apparatus such as a CRT or an LCD, a communication apparatus such as a modem that carries out communication with the outside, an output apparatus such as a printer, and a control apparatus that receives input from the input apparatus and that controls the operations of the communication apparatus, the output apparatus, and the display apparatus.

In the above-described computer system, a control unit may include, as functional blocks realized by the execution of a program that is stored in a memory unit: a data distribution learning unit that receives, as input, data in which the state of a network is expressed by matrix variables of a hierarchical structure and that learns the state of the above-described network as a probability distribution of the above-described matrix variables; and a fault detection unit that, based on the result of learning by the data distribution learning unit, detects as a fault of the above-described network a state in which the above-described probability distribution has transitioned from the distribution that indicates a normal state of the above-described network to a distribution that indicates another state.

In the above-described configuration, the above-described data distribution learning unit includes: a structure candidate enumeration means that enumerates a plurality of different structures as candidates that correspond to the hierarchical structure of the above-described data that were received as input; a model generation means that generates, for each of the structures enumerated in the above-described structure candidate enumeration means, a probability model including matrix variables of the same hierarchical structure as the structure; a distribution learning means that, for each of the probability models generated by the above-described model generation means, updates the parameters given as the matrix variables of the probability model based on the above-described data that were received as input; and a model selection means that, for each of the probability models for which parameters have been updated in the above-described distribution learning means, calculates a value of an information criterion that is an index of model selection and selects as the optimum model the probability model in which the value of the information criterion is a minimum; and the above-described fault detection unit may be configured to carry out determination of faults of the above-described network based on the result of learning relating to the probability distribution of the matrix variables of the optimum model that was selected in the above-described model selection means. In this case, the above-described structure candidate enumeration means may, upon selection of an optimum model in the above-described model selection means, enumerate, as the above-described candidates, a plurality of different structures that resemble the hierarchical structure of the optimum model that was selected.

In the configuration shown in FIG. 1, the above-described data distribution learning unit may be made up of functional blocks that correspond to neighboring structure generation unit 22, model generation unit 31, model parameter updating unit 41 and optimum model selection unit 51, and the fault detection unit may be made up by functional blocks that correspond to fault score calculation means 6 and structural change detection means.

The present invention as described above exhibits the following effects.

For example, in the traffic on a network, a hierarchical structure may occur in various locations in which there are hubs that perform important work in a particular area and, when viewed over an even wider area, there are hubs that consolidate these hubs. When an abnormality such as the occurrence of a worm occurs in a network of this structure, the entire network may exhibit the same type of traffic or peculiar behavior may occur in only parts of the network.

In the present invention: data that represent the state of the network by matrix variables of a hierarchical structure (including typical graph hierarchical structures such as tree structures and self-similar structures) are received as input; the state of the network is learned as the probability distribution of the matrix variables; and based on the result of this learning, a state in which the probability distribution transitions from a distribution that indicates the normal state of the network to a distribution that indicates another state is detected as a network fault. In this way, changes in the structure of the network can be monitored and the occurrence of faults such as the occurrence of a worm can be detected. By thus implementing detection of abnormalities that takes into consideration the structure of the network, the accuracy of fault detection can be improved.

In addition, probability distributions that hold as parameters a matrix that has a hierarchical structure that represents the state of the network can be learned, and the hierarchy of the parameter matrix that changes sharply can be detected, whereby partial structural changes can also be detected when viewing changes of the network structure. In addition, the type of structural change from which an abnormality was generated can also be presented, whereby the readability of the detection results can be improved.

As shown in Non-Patent Documents 1 and 2, scale-free structures and self-similar structures exist as characteristic structures in actual networks. A scale-free structure has a configuration in which a small number of vertices that serve as hubs are linked to a multiplicity of vertices, and in turn, a still smaller number of hubs are linked to this small number of hubs, whereby a scale-free structure can be called one type of hierarchical structure. In addition, a self-similar structure is also a hierarchical structure in which every hierarchy has the same form. According to the present invention, fault detection is carried out that takes into consideration the hierarchical structure of a network, and this fault detection can therefore be easily applied to an actual network.

The network fault detection apparatus of the present invention described hereinabove can be applied to all types of networks in which elements have mutual correlations.

Although the present invention has been described with reference to an exemplary embodiment, the present invention is not limited to the above-described exemplary embodiment. The configuration and operation of the present invention is open to various modifications within a scope that does not depart from the spirit of the present invention that will be understood by one of ordinary skill in the art.

This application claims priority based on JP-A-2008-5603 for which application was submitted on Jan. 15, 2008 and incorporates all of the disclosures of that application.

What is claimed is:

1. A network fault detection apparatus comprising:
a data distribution learning unit that takes as input data that represent the state of a network by matrix variables of a hierarchical structure and that learns the state of said network as the probability distribution of said matrix variables; and
a fault detection unit that, based on the result of learning by said data distribution learning unit, detects as a fault of said network a state in which said probability distribution transitions from a distribution that indicates the normal state of said network to a distribution that indicates another state.

2. The network fault detection apparatus as set forth in claim 1, wherein said data distribution learning unit includes:
a structure candidate enumeration unit that enumerates a plurality of different structures as candidates that correspond to a hierarchical structure of said data that is received as input;
a model generation unit that generates, for each of structures enumerated in said structure candidate enumeration unit, a probability model having matrix variables of the same hierarchical structure as the structure;
a distribution learning unit that, based on said data that are received as input, updates, for each probability model generated by said model generation unit, parameters given as matrix variables of the probability model; and
a model selection unit that, for each probability model for which parameters have been updated in said distribution learning unit, calculates a value of an information criterion that is an index of model selection, and selects as an optimum model a probability model for which the value of the information criterion is a minimum;
wherein said fault detection unit detects faults of said network based on the result of learning relating to the probability distribution of matrix variables of an optimum model that was selected in said model selection unit.

3. The network fault detection apparatus as set forth in claim 2, wherein said structure candidate enumeration unit, upon selection of an optimum model in said model selection unit, enumerates as said candidates a plurality of different structures that resemble the hierarchical structure of the optimum model that was selected.

4. The network fault detection apparatus as set forth in claim 3, wherein said fault detection unit includes a fault score calculation unit that calculates a fault score that indicates the difference between input data that are given by an optimum model selected in said model selection unit and input data when said network is in a normal state.

5. The network fault detection apparatus as set forth in claim 4, wherein said fault score calculation unit determines whether or not said fault score has exceeded a threshold value and supplies the determination result as output.

6. The network fault detection apparatus as set forth in claim 2, wherein said fault detection unit includes a structural change detection unit that, based on an optimum model selected in said model selection unit, detects changes of the hierarchical structure of said network.

7. A network fault detection method that is carried out in a computer system that receives as input data in which the state of a network is represented by matrix variables of a hierarchical structure, said method comprising:
based on said data that are received as input, learning, in a data distribution learning unit, the state of said network as the probability distribution of said matrix variables; and
based on the results of learning by said data distribution learning unit, detecting, in a fault detection unit, a state in which said probability distribution transitions from a distribution that indicates the normal state of said network to a distribution that indicates another state as a fault of said network.

8. The network fault detection method as set forth in claim 7, wherein said learning by said data distribution learning unit includes:
enumerating a plurality of different structures as candidates that correspond to a hierarchical structure of said data that were received as input;
generating, for each structure that was enumerated in said first step, a probability model having matrix variables of the same hierarchical structure as the structure;
for each probability model generated in said second step, updating, based on said data that were received as input, parameters that were given as matrix variables of the probability model; and
for each probability model for which parameters were updated in said updating, calculating a value of an information criterion that is an index of model selection and selecting, as an optimum model, the probability model for which the value of the information criterion is a minimum;
wherein the fault detection by said fault detection unit is to detect a fault of said network based on the result of learning relating to the probability distribution of the matrix variables of said optimum model that was selected in said calculating of said value.

9. The network fault detection method as set forth in claim 8, wherein said enumerating by said data distribution learning unit is to enumerate as said candidates a plurality of different structures that resemble the hierarchical structure of the optimum model that was selected in said calculating of said value.

10. The network fault detection method as set forth in claim 8, wherein the fault detection by said fault detection unit includes a calculating a fault score that indicates the difference between input data given by the optimum model selected in said calculating of said value and input data in the normal state of said network, and detecting a fault of said network based on the result of calculating the fault score.

11. The network fault detection method as set forth in claim 8, wherein the fault detection by said fault detection unit includes detecting a change of the hierarchical structure of said network based on an optimum model that was selected in said calculating of said, value, and detecting a fault of said network based on the result of detecting structure change.
